(19) United States
(12) Patent Application Publication
(10) Pub. No.: US 2019/0352732 A1
(43) Pub. Date: Nov. 21, 2019

(54) Electric Induction System and Method for Metallurgically Heat Treating Coil Springs

(71) Applicant: Inductoheat, Inc., Madison Heights, MI (US)

(72) Inventors: Timothy Gerard BOUSSIE, Sterling Heights, MI (US); Paul Timothy Briggs, South Lyon, MI (US)

(21) Appl. No.: 16/416,175

(22) Filed: May 18, 2019

Related U.S. Application Data
(60) Provisional application No. 62/674,254, filed on May 21, 2018.

(51) Int. Cl. C21D 9/02; H05B 6/10; H05B 6/36; H05B 6/44; H05B 6/06; C21D 1/42

(52) U.S. Cl. CPC C21D 9/02; H05B 6/102; C21D 1/42; H05B 6/44; H05B 6/06; H05B 6/36

(57) ABSTRACT

A coil spring electric induction heat treatment system and method of metallurgical heat treatment of coil springs within a heat treatment region formed by a channel inductor with a spring support structure is provided. The spring support structure is alternatively a planar surface or a series of continuously moving slats positioned below the heat treatment region that rotate the coil springs during the heat treatment process.

### CROSS REFERENCE TO RELATED APPLICATIONS

This application claims the benefit of U.S. Provisional Application No. 62/674,254, filed May 21, 2018, hereby incorporated by reference in its entirety.

### FIELD OF THE INVENTION

The present invention relates to electric induction systems and methods of metallurgically heat treating coil springs and such systems and methods where the heating is performed with a channel inductor associated with a coil spring support system for support of the spring during heating and release of the spring from the channel inductor after heat treatment to another heat treatment station such as a quenchant heat treatment station.

### BACKGROUND OF THE INVENTION

The article “coil spring,” which is also known as a helical spring, as used herein includes various configurations of coil springs known in the art, including constant or variable pitch cylindrical coil springs; conical, barrel and hourglass coil springs that are wire wound or machined.

The term “heat treatment” as used herein refers to annealing, hardening, stress relieving, tempering or quenching, and any combination thereof.

It is known in the art of heat treating coil or helical springs by electric induction processes to support and rotate the spring in a system utilizing non-electrically conductive support rollers that close around the outer circumference of the spring while the spring is inductively heated from two sides of the longitudinal coil legs of a channel inductor when a magnetic field is generated by a current flow supplied from an alternating current (AC) power source to the coil legs, for example, as disclosed in U.S. Pat. No. 8,912,472.

FIG. 1 is a transverse cross sectional view of helical spring 190 nominally passing through two rectangularly shaped coil legs 102a and 102b of channel inductor 102. Upon completion of one or more heating cycles in the heat treatment process, closed spring support rollers 106a and 106b are opened (spread apart from each other) in the directions of the double-headed arrow shown in FIG. 3 and a heat treated (for example austenitized) spring free falls into a quenchant bath as disclosed in U.S. Pat. No. 8,912,472.

The above type of helical spring hardening system and process is typically not versatile in being capable of hardening a wide variety of helical springs with different geometric characteristics. Varying geometric characteristics include springs with different diameters, including variable diameter springs such as conical springs; springs with different cross sectional shapes; springs formed from different lengths and shapes of wires; and springs with different shapes of end terminals, for example flattened end terminals for springs formed with cross sectional circular wires.

The above type of helical spring hardening system and process is also susceptible to an electromagnetic decoupling effect between the electromagnetic field established by AC current flow through channel inductor 102 and spring 190 being heated that results in an appreciable decline in induced heating efficiency of the spring and therefore quality of the spring's heat treatment. As illustrated in FIG. 2 without stable support of the spring during the heating process, spring 190, or regions of the spring, can deviate from the nominal spring positioning in FIG. 1 where the longitudinal central axis of spring 190 is centered between the opposing heating faces of channel inductor's rectangular longitudinal legs 102a and 102b at centered position “C”. The curvature of spring support rollers 106a and 106b on which the springs are supported as shown in FIG. 3 will always result in the springs between the longitudinal legs being positioned lower than centered position “C”. Deviation from nominal spring positioning can, for example, result from mechanical backlash or play in support rollers 106a and 106b or can also be associated with differences in the gaps between the inductor legs and the larger and smaller regions of a conical spring.

Heating a complex shaped coil spring with the apparatus and method shown in FIG. 2 and FIG. 3 to a uniform temperature along its entire axial length is not feasible. The term complex shaped coil spring in the present context includes coil springs having a variable cross sectional dimension along its overall axial length. Generally the coil axial length will be the free coil axial length unless the coil spring is being heated, for example, when compressed to a compressed coil length and the cross sectional dimension will be an inner or outer diameter. Examples of a complex shaped coil spring include conical, barrel and hourglass coils springs. FIG. 4(a) illustrates a spring electric induction heating apparatus where three identical conical springs 190 (illustrated diagrammatically in a conic section outline, for example, of a volute spring) are being batch heated in the apparatus described in FIG. 2 and FIG. 3. Each conical spring has a small end 190b outer diameter of dl and an opposing large end 190a outer diameter of d2.

Heating of complex shape springs with longitudinally linear support rollers 106a and 106b, for example, longitudinally non-symmetrical springs with an outer cross sectional form of a conic section will always result in off-center spacing and electromagnetic decoupling variations in selected regions of the conical springs. FIG. 4(a) illustrates three identical conical springs in the process of heat treatment through the longitudinal legs of channel inductor 102 and is representative of a multiple spring processing line when high production rates of heated treated springs must be met. The gap distance g₁ between the smaller cross sectional end 190b of the spring and inductor legs 102a and 102b will be larger than the gap distance g₂ at the larger cross sectional end of the spring and the inductor legs resulting in different degrees of electromagnetic coupling (and therefore heating) along the longitudinal axial length of the spring and will always result in the spring being positioned lower than the centered position for at least some of the longitudinal axial length of the spring.

FIG. 4(b) illustrates in transverse cross sectional view the variation of magnetic coupling between conical spring ends 190a and 190b with channel inductor 102. Variations in electromagnetic coupling between longitudinal legs 102a and 102b of the channel inductor and different ends of a conical spring transported in-line continuous fashion by straight cylinder rollers 106a and 106b inevitably produce different intensities at the spring's local areas resulting in harmful temperature non-uniformity along the length of the heat treated spring.

Without a support system providing consistently stable support to the spring during the heat treatment process, the entire spring, or at least a section of the spring, can deviate from centered positon “C”, for example, to the alternative off-center spring positions 190a or 190b shown in FIG. 2 which results in appreciable decline in induced heating efficiency as illustrated by sample flux field lines 104a and 104b shown in the figures and increase temperature non-uniformity in the spring.

As illustrated in FIG. 3 support rollers 106a and 106b can be provided to maintain the spring at a relatively constant horizontal position with respect to the rectangular legs of the channel inductor subject to mechanical backlash or play in the support roll system and will rotate the spring, for example, clockwise with central axial rotation of the rollers as indicated by the two rotational arrows, to achieve 360 degrees of heating around the circumference of the spring. However use of support rollers prevents positioning of the spring in the nominal centered position “C” shown in FIG. 1 where the electromagnetic field produces the greatest induced heat intensity, highest spring heating efficiency and optimum spring temperature uniformity.

Further a mechanical roll system is subject to mechanical failure and wearing of parts over its operational life cycle.

It is one object of the present invention to provide an electric induction system and method for metallurgically heat treating a coil spring where the coil spring is retained in a centered position between the opposing legs of a channel inductor with a coil spring support system independent of components without mechanical backlash or play that can cause the coil spring to deviate from the centered position between the opposing legs of the channel inductor during the heat treatment process.

It is another object of the present invention to provide an electric induction system and method for metallurgically heat treating a coil spring where the coil spring is retained in a centered position between the opposing legs of a channel inductor with a coil spring support system independent of components with mechanical backlash or play that can cause the coil spring to deviate from the centered position between the opposing leg of the channel inductor or mechanical malfunction when advancing the heat treated spring to the next heat treatment station.

It is another object of the present invention to provide an electric induction system and method for metallurgically heat treating a coil spring having a complex geometry where control of the temperature distribution along the axial length of the spring is required.

### BRIEF SUMMARY OF THE INVENTION

In one aspect the present invention is an electric induction system and method for metallurgically heat treating coil springs within a spring heat treatment region between facing surfaces of rectangular shaped legs of a channel inductor with the coil springs separated from the facing surfaces of the rectangular shaped legs by side guides.

In another aspect the present invention is an electric induction system and method for metallurgically heat treating coil springs within a spring heat treatment region between facing surfaces of rectangularly shaped legs of a channel inductor with the coil springs separated from the facing surfaces of the rectangular shaped legs by side guides; a lower coil spring support structure for centering the coil springs between the rectangularly shaped legs is provided.

In another aspect the present invention is an electric induction system and method for metallurgically heat treating coil springs within a spring heat treatment region between facing surfaces of rectangularly shaped legs of a channel inductor with the coil springs separated from the facing surfaces of the rectangularly shaped legs by side guides; a lower coil spring support structure for centering the coil springs between the rectangular shaped legs and friction rolling the coil springs during one or more heat treatment cycles.

In another aspect the present invention is an electric induction system and method for metallurgically heat treating coil springs within a spring heat treatment region between facing surfaces of rectangular shaped legs of a channel inductor with the coil springs separated from the facing surfaces of the rectangular shaped legs by side guides; a lower coil spring support structure for centering the coil springs between the rectangular shaped legs and for friction rolling the coil springs during one or more heat treatment cycles and releasing the coil springs from the heat treatment station to another heat treatment station or heat treated spring storage location.

In another aspect the present invention is an electric induction system and method for metallurgically heat treating coil springs having a complex geometry within a spring heat treatment region between facing surfaces of rectangular shaped legs of a channel inductor where one or more flux concentrators are positioned relative to regions of the complex geometrically shaped coil springs to control the induced heat temperature distribution along the axial length of the complex geometrically shaped coil springs.

The above and other aspects of the invention are set forth in this specification and the appended claims.

### BRIEF DESCRIPTION OF THE DRAWINGS

The appended drawings, as briefly summarized below, are provided for exemplary understanding of the invention, and do not limit the invention as further set forth in this specification and the appended claims.

FIG. 1 is a simplified diagrammatic transverse cross sectional view of a nominally centered helical spring between the rectangular legs of a channel inductor during a heat treatment process.

FIG. 2 is a simplified diagrammatic transverse cross sectional view of a helical spring deviating from the nominal centered position in FIG. 1 during a heat treatment process.

FIG. 3 is a simplified diagrammatic transverse cross sectional view of a helical spring being held in a horizontal plane by a pair of rollers and rotated during a heat treatment process.

FIG. 4(a) is a simplified diagrammatic top plan view of the heating apparatus of FIG. 2 and FIG. 3 batch heating three complex shaped conical springs.

FIG. 4(b) is a simplified diagrammatic transverse cross sectional view of one of the three complex shaped conical springs being heated in the heating apparatus of FIG. 4(a).

FIG. 5 is one example of an electric induction system of the present invention with a heat treatment station and a coil spring heating and release support structure with the support structure shown in the springs loaded position.

FIG. 6(a) is one example of a coil spring feed apparatus for use with the electric induction system of the present invention with the support structure shown in the springs loaded position.

FIG. 6(b) is an enlarged detail view of the coil spring feed apparatus shown in FIG. 6(a).

FIG. 6(c) is the electric induction system shown in FIG. 6(a) with the support structure shown in the heated springs release position after the springs in the heat treatment region have been heated.

FIG. 7(a) is a top plan view of the electric induction system shown in FIG. 5 with the support structure in the springs loaded position.

FIG. 7(b) is a top plan view of the electric induction system shown in FIG. 5 with support structure in the heated springs release position after the springs in the heat treatment region have been heated.

FIG. 8(a) is a top plan view of an alternative coil spring heating and release support system for use with an electric induction heat treatment station of the present invention.

FIG. 8(b) through FIG. 8(e) illustrate movement of the support structure in FIG. 8(a) sequentially through a first spring batch loaded position to a spring heat treatment region; a first heated spring batch release position from the spring heat treatment region; a second spring batch loaded position to the spring heat treatment region; and a second heated spring batch release position from the spring heat treatment region.

FIG. 9(a) and FIG. 9(b) are side elevation views of an alternative example of an electric induction system of the present invention respectively illustrating the system in a spring loaded and heating position and a heated springs release position after the springs in the heat treatment region in FIG. 9(a) have been heated.

FIG. 10(a) through FIG. 10(c) is an alternative example of the electric induction heating system of the present invention shown in FIG. 9(a) and FIG. 9(b).

FIG. 11 is one embodiment of an electric induction heating system of the present invention where magnetic flux concentrators are applied to a channel coil's leg regions corresponding to electromagnetically decoupled regions of a complex shaped coil spring to intensify induction heating of the electromagnetically decoupled regions to achieve a more uniform axial (longitudinal) temperature distribution of the complex shaped coil spring.

### DETAILED DESCRIPTION OF THE INVENTION

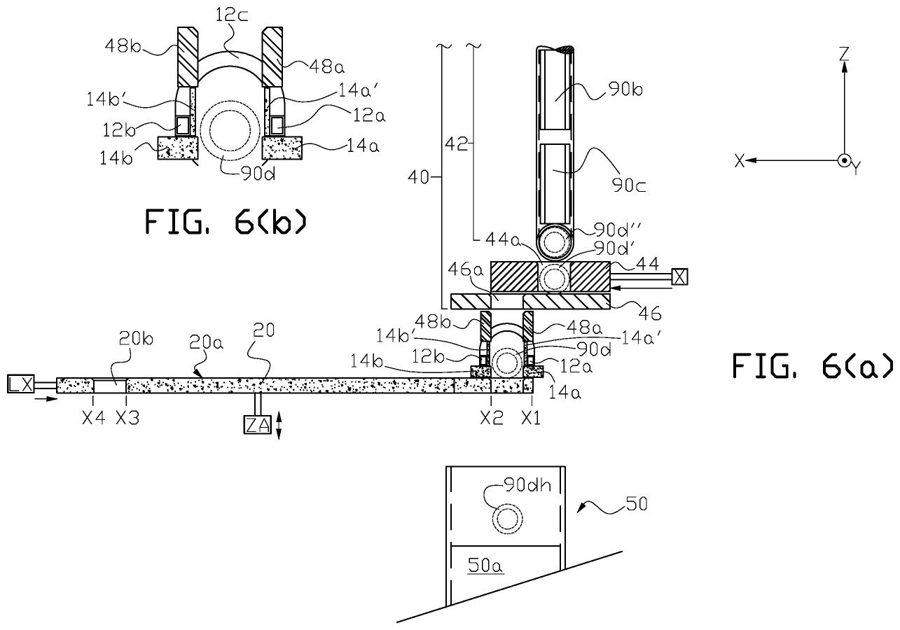

There is shown in FIG. 5 one example of a coil spring electric induction heat treatment system 10 of the present invention for metallurgically heat treating coil springs. One or more coil springs (shown diagrammatically in outline form as right circular cylinders in the figure) are loaded into a spring heat treatment region between a pair of planarly spaced apart, rectangularly oriented inductor legs 12a and 12b of channel inductor 12 with interior spring side guides 14a and 14b.

In the example of the invention shown in the figures, channel inductor 12 has opposing end inductor crossover sections 12c and 12d formed as raised arcuate sections at the adjacent opposing first ends and the adjacent opposing second ends of inductor leg 12a and inductor leg 12b to form a series electrically connected channel inductor. Other arrangements of connecting the inductor legs as known in the art can be used.

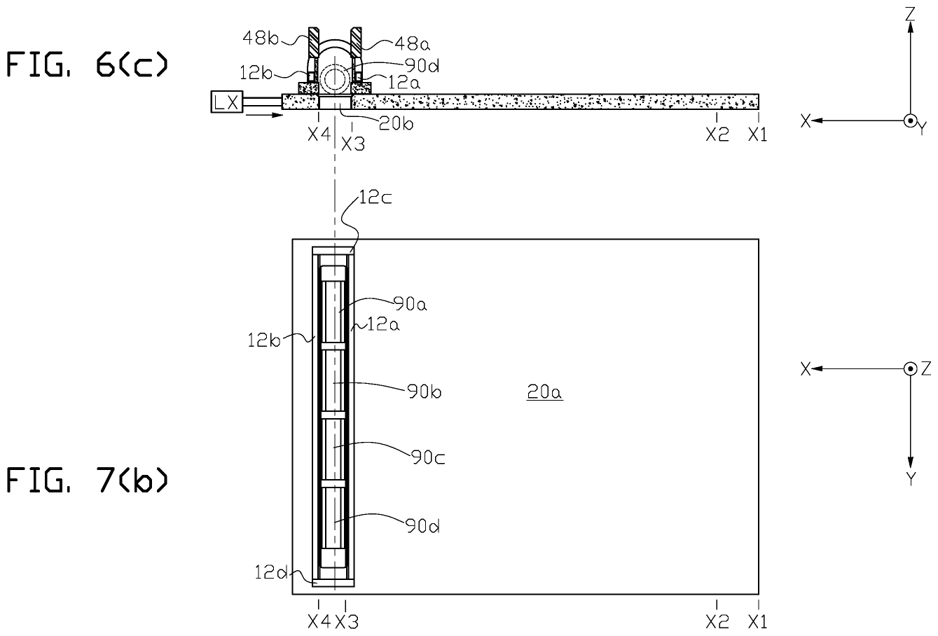

Single phase power terminals in the channel inductor that supply alternating current (AC) to the channel inductor from an AC power source can be provided as known in the art. For example, two single phase power terminals T1 and T2 can be connected to the channel inductor, as shown in FIG. 7(a), adjacent to each other in one of the end inductor crossover sections 12c with an electrical insulator 92 between the two single phase power terminals.

In the example shown in FIG. 5 the length, Lhtr, of the spring heat treatment region between the rectangular inductor legs is sufficiently long in the Y-direction to heat four springs 90a, 90b , 90c and 90d simultaneously. The four springs are referred to collectively as springs 90. In other examples of the invention the spring heat treatment region may be configured to simultaneously heat one or more springs.

In some embodiments of the invention a non-electrically conductive spacer element (not shown in the figures) is inserted between adjacent springs in the heat treatment region to maintain separation between the springs during the heat treatment process in the spring heat treatment region.

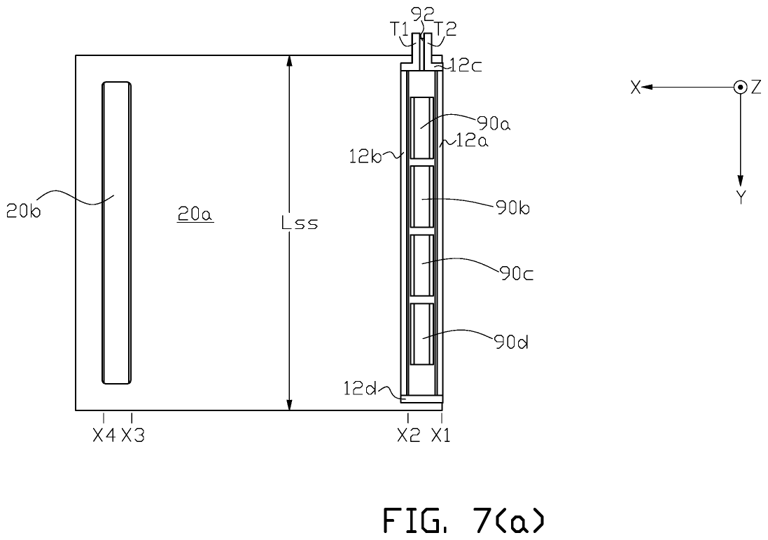

One method of loading (or depositing) the one or more coil springs into the spring heat treatment region is shown in FIG. 6(a) as an overhead loader system 40 with which multiple coil springs can be heat treated at the same time in the spring heat treatment region. Vertically oriented (Z-direction) moveable feed tube 42 is configured to lay multiple springs 90 in horizontal (Y-direction) escapement channel 44a that has a moveable closed bottom in FIG. 6(a) formed from the top surface of spring load element 46. For the example of four springs in FIG. 5, in FIG. 6(a) vertically oriented feed tube 42 moves in the negative Y-direction over the horizontal escapement channel 44a to horizontally lay down springs 90d, 90c, 90b and 90a sequentially in the escapement channel with placement orientation as shown in FIG. 5. As shown in FIG. 6(a), spring 90d is shown in four alternative sequential positions as: spring 90d″ being laid down horizontally from moving vertically oriented feed tube 42; spring 90d′ after dropping down into escapement channel 44a; spring 90d seated in the spring heat treatment region; and spring 90dh that has been heat treated and is dropping down into quenchant 50a in quench tank 50. Springs 90c, 90b and 90a move simultaneously through these four sequential positions in this batch heat treatment of the four springs. If non-electrically conductive spacer elements are used in an embodiment of the invention, they can also be appropriately loaded into escapement channel 44a. Escapement element 44, which may be configured as a rectangular block with escapement channel 44a within the escapement element, is in the escapement channel load position in FIG. 6(a). In this example of the invention a suitable escapement actuator X is configured to move escapement element 44 in the positive X-direction as indicated by the X arrow in FIG. 6(a) until escapement channel 44a aligns with spring load channel 46a in spring load element 46. In the illustrated embodiment of the invention spring load channel 46a is positioned over the top of the spring heat treatment region formed between the two rectangular legs of the channel inductor on vertical offset elements 48a and 48b. Overhead loader system 40 is moveably positioned over the heat treatment region by a loader system actuator. Alignment of escapement channel 44a with spring load channel 46a enables the four horizontally oriented coil springs 90 (and spacer elements if used) loaded in escapement channel 44a to gravity fall into the spring heat treatment region.

One or more non-electrically conductive spring interior side guides 14a and 14b are provided between the interior facing surfaces of the rectangular inductor leg sections and the springs in the spring heat treatment region. Spring side guides 14a and 14b may be formed as electrical insulation material bonded to the inductor leg sections, or as separate guides suitably attached to the inductor leg sections, for example, by an adhesive. For convenience the phrase “attached to the inductor leg” is used to describe various types of attachments to the inductor legs. In the example of FIG. 5 each side guide 14a and 14b comprises a rectangularly shaped element fitted below the inductor leg sections that extends into the spring heat treatment region further than the inductor legs sections. In the example of FIG. 6(a) the side guides comprise rectangularly shaped elements 14a and 14b fitted below the inductor leg sections 12a and 12b and supplementary side wall guides 14a′ and 14b′ as best seen in the detail of FIG. 6(b). In other examples of the invention only the supplementary interior side (wall) guides are used and may be referred to generally as interior spring side guides.

Coil spring combination heat treatment positioning and escapement structure, which is referred to as a coil spring support structure 20 is formed at least partially from non-electrically conductive material so as not to electrically interact with the magnetic flux field generated when alternating current flows through channel inductor 12. In the embodiment of the invention shown in the figures support structure 20 has at least an upper surface 20a formed as a flat planar surface and has a support structure length Lss at least as great as the length Lhtr of the spring heat treatment region.

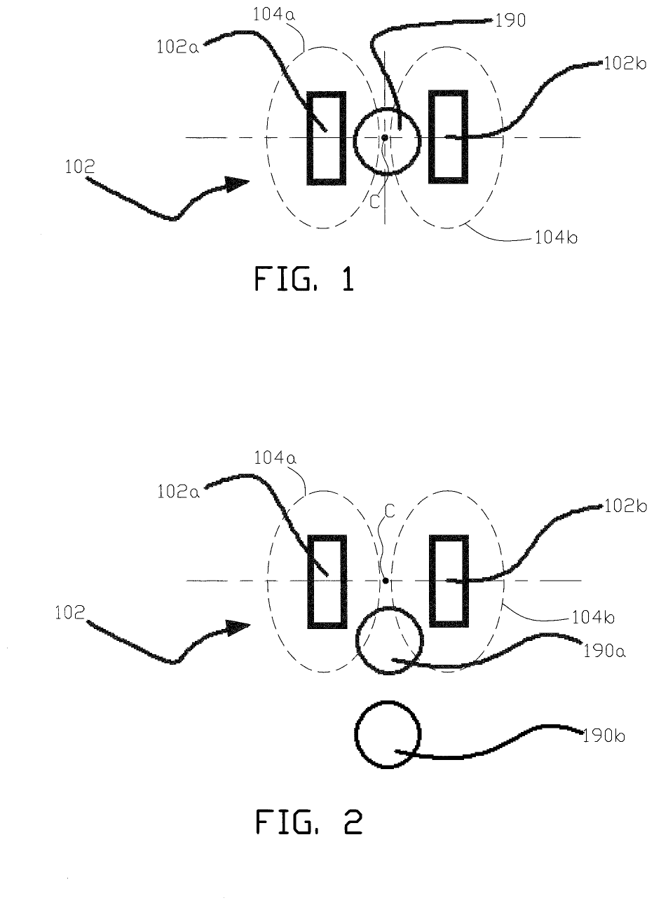

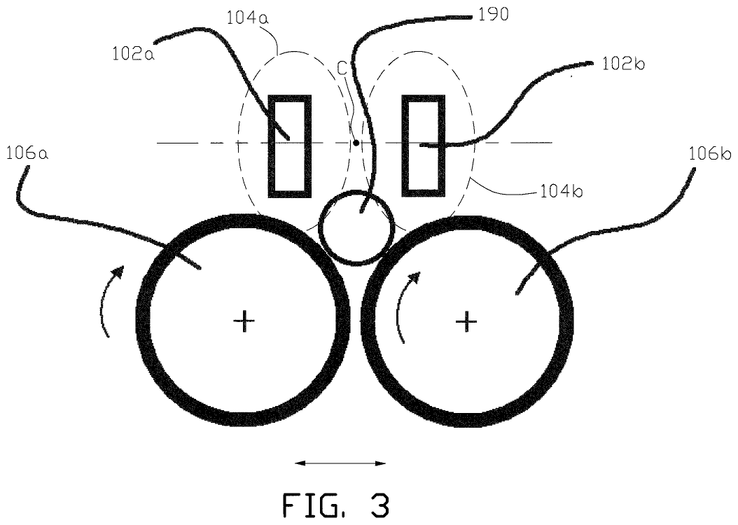

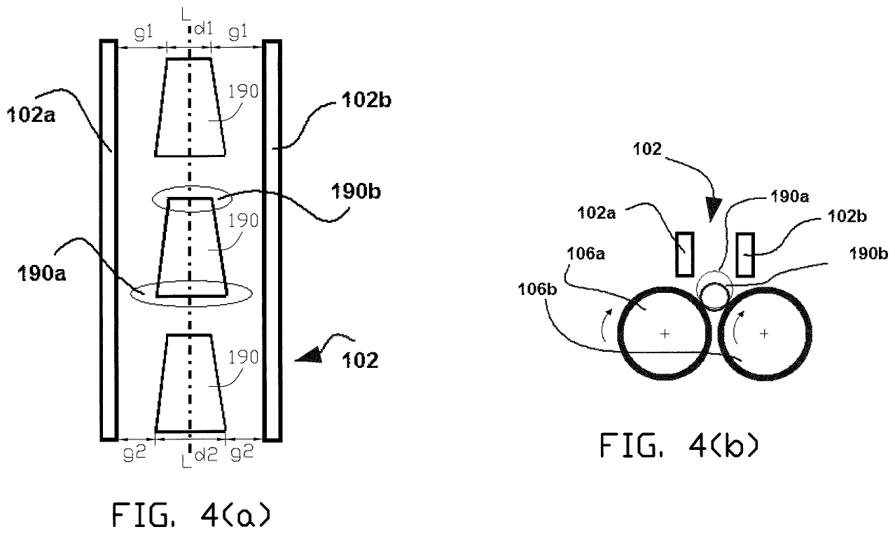

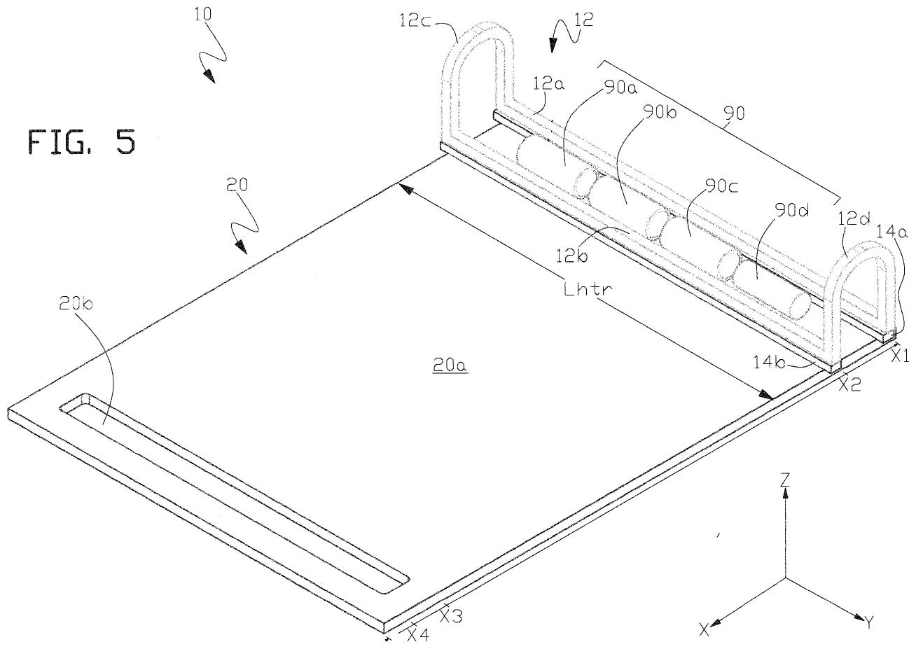

In some embodiments of the invention the channel inductor legs 12a and 12b are fixed in height over support structure 20 so that the height of the opposing faces of the rectangular inductor leg sections 12a and 12b position springs seated on the upper surface 20a of support structure 20 in the spring heat treatment region with the springs' longitudinal central axes centered between the opposing heating faces of the channel inductor's rectangular longitudinal legs at centered position “C” as shown in FIG. 1.

In other examples of the invention a channel inductor Z-direction actuator (for example ZA in FIG. 6(a)) is provided so that the height (Z-direction) of the channel inductor's rectangular inductor leg sections can be varied depending upon variations in the geometric characteristics of the springs being heated in the spring heat treatment region so that the springs are seated on coil spring support structure 20 at the nominal centered position “C” of the spring heat treatment region.

In some embodiments of the invention, heating of the springs loaded into the spring heat treatment region either with the overhead loader system or other suitable spring loading apparatus, can be accomplished by supplying AC current to channel inductor 12 with the channel inductor and support structure 20 held stationary in the springs loaded position, for example, shown in FIG. 5.

In other embodiments of the invention, coil spring support structure 20 is connected to an X-direction spring friction roll linear actuator (for example LX in the figures) configured to horizontally move support structure 20 in the +X and −X directions along the width of the support structure as defined by the three-dimensional Cartesian coordinate system in the figures in an oscillatory (or non-oscillatory) motion within a maximum support structure horizontal oscillatory heat boundary limits (stroke). For example, with reference to the horizontal locations X1, X2, X3 and X4 in the X-direction in FIG. 5 through FIG. 7(b) of the support structure maximum support structure horizontal oscillatory (or non-oscillatory) heat boundary limits are defined between the springs loaded position shown in FIG. 5 or FIG. 6(a) and horizontal movement of the support structure in the −X direction (to the right in the figures) no further than where location X3 is located to avoid release of the springs in the heat treatment region by allowing slotted opening 20b in coil spring support structure 20 between locations X3 and X4 to horizontally align beneath the spring heat treatment region before the spring heating process is completed.

In the embodiments of the invention where the oscillatory heating motion is performed, the heat treatment station (channel inductor and the spring heat treatment region formed between the inductor legs with interior spring side guides) can be structurally fixed independent from horizontally moving support structure 20 so that the oscillatory motion of support structure 20 rotates springs 90 in the spring heat treatment region by a friction force established between the springs seated on the support structure's upper surface 20a and the upper surface with sufficient spring rotation to achieve uniform heat treatment around the entire circumference of each spring in a heating process of the present invention.

Upon completion of a spring heat treatment process for a particular application, the support structure's X-direction spring friction roll linear actuator, LX, can linearly index support structure 20 so that the support structure's spring release region between locations X3 to X4 in FIG. 6(a) through FIG. 7(b) (with support structure slotted opening 20b in the support structure) is positioned under the spring heat treatment region as shown in FIG. 6(c) and FIG. 7(b). Heated springs 90 in the heat treatment region can then gravity free fall to the next heat treatment station that may be a quenchant heat treatment, for example, quenchant 50a in quench tank 50 in FIG. 6(a). In some embodiments of the invention a support structure slotted opening 20b is not provided in the support structure and another method of removal of the heat treated springs from the support structure is used.

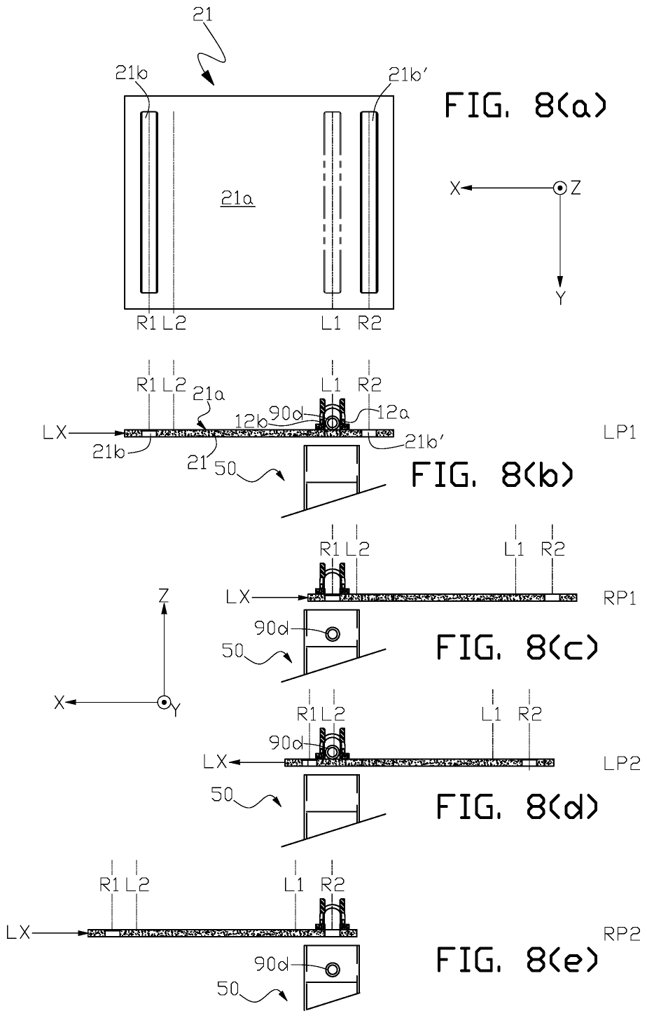

In other embodiments of the invention, multiple spring load positions and heated spring release positions can be provided with a single horizontally moving support structure. For example in FIG. 8(a) through FIG. 8(e), locations L1 (spring load position 1); L2 (spring load position 2); R1 (heated spring release position 1) and R2 (heated spring release position 2) are respectively: spring heat treatment region 1 on the upper surface 21a of support structure 21; spring heat treatment region 2 on the upper surface; slotted opening 21b in the support structure 21; and slotted opening 21b′ in the support structure, with support structure 21 configured for horizontally moving in the +X direction (to the left in the figures) or −X direction (to the right in the figures). Channel inductor 20 remains in the stationary position shown in the figures as support structure 21 moves horizontally during the process steps illustrated in FIG. 8(b) through FIG. 8(e) and is configured as in other examples of the invention. In one embodiment of the invention, the induction heat treatment process begins with the loading of one or more springs (first spring batch) in position LP1 in FIG. 8(b). Support structure 21 moves horizontally in the −X direction (to the right in the figures as illustrated diagrammatically by actuator arrow LX) from position LP1 after loading the first spring batch to positon RP1 in FIG. 8(c) to release the first heated spring batch that was inductively heated during movement (oscillatory or non-oscillatory) between positions LP1 and RP1 as in other examples of the invention. Support structure 21 moves horizontally in the +X direction (to the left in the figures) from position RP1 to position LP2 in FIG. 8(d) for loading a second spring batch. Support structure 21 moves horizontally in the +X direction (to the left in the figures) from position LP2 after loading the second spring batch to positon RP2 in FIG. 8(e) to release the second heated spring batch that was inductively heated during movement (oscillatory or non-oscillatory) between position LP2 and RP2. Support structure 21 then moves horizontally in the −X direction (to the right in the figures) from position RP2 to position LP1 in FIG. 8(b) for loading another spring batch, with the loading, heating and release process steps cycling repeatedly in this example of the invention.

In one embodiment of the invention the quenchant heat treatment station comprises at least one quench tank 50. A quenched spring drag out conveyor (not shown in the figures) is provided to receive quenched springs and convey them out of the quench tank. At least one quenchant pump, quenchant immersion heater and heat exchanger (not shown in the figures) are provided to support the at least one quench tank 50 with the pump circulating the quenchant media through heat exchanger and to jets or water spray heads to provide sufficient agitation to quench the heated springs to a specified degree for a particular application.

In some embodiments of the invention, for example, when the coil springs have non-cylindrical shapes, the upper surface of the support structure may be contoured or articulated for at least a partial seating in the spring heat treatment region during the heat treatment process to assist in ensuring the central longitudinal axis of a spring being heated is in the axial centered position “C” as shown in FIG. 1.

In some embodiments of the invention, alternative to movement of support structure is movement of the heat treatment station with the heat treatment region between the inductor legs while the support structure is stationary, or both the support structure and the heat treatment station are moveable relative to each other to perform a friction roll (oscillatory or non-oscillatory) heat treatment process step and the spring release process step. In general these alternative movements of the support structure and heat treatment station are described as a relative movement of the heat treatment region over the coil spring support structure.

The support structure may be other shapes to accomplish the friction roll heat treatment process step and the release process step. For example the support structure may be of parabolic shape with the spring heat treatment station disposed at the inner minimum vertex of the parabolic surface with a parabolic actuator rotating around the fixed heat treatment station so that the friction roll heat treatment process steps is accomplished by rolling the springs in the heat treatment region over the interior surface of the parabolic support structure and the heated spring release process step is accomplished by rotating the parabolic support structure away from the inner minimum vertex of the parabolic surface.

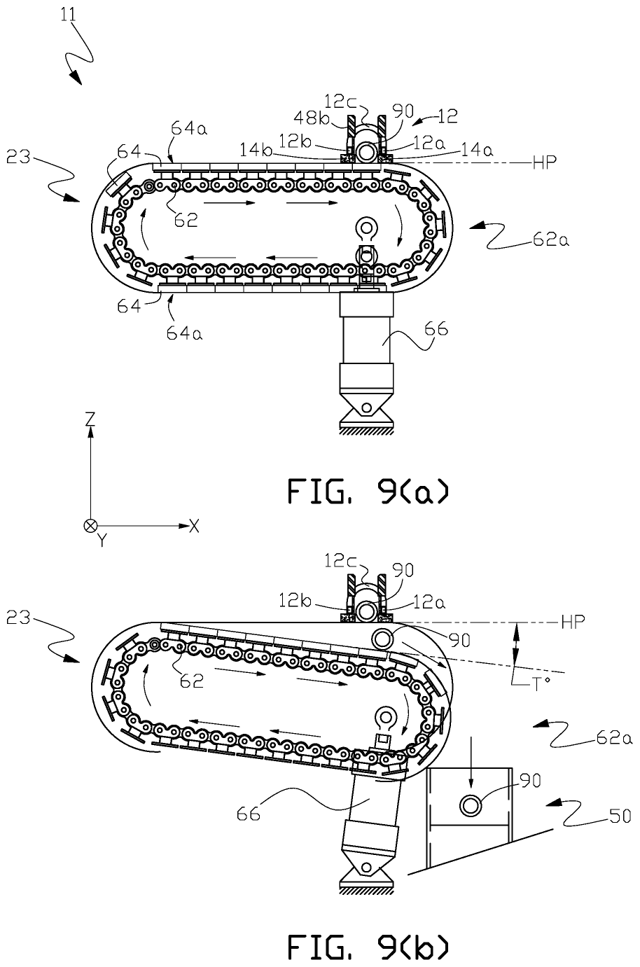

FIG. 9(a) and FIG. 9(b) illustrate an alternative example of a coil spring electric induction heat treatment system 11 of the present invention for metallurgically heat treating coil springs where the induction heat treatment station comprising channel inductor 12 and the spring heat treatment region positioned between the inductor legs 12a and 12b and the interior spring side guides, is similar to the heat treatment station and region in other examples of the invention disclosed herein. The coil spring combination heat treatment positioning and release structure, which is referred to as support structure 23, is formed from a mechanically (or otherwise) driven closed loop rotatable component, for example belt or chain 62, (also referred to as a rotatable loop drive) to which a plurality of non-electrically conductive individual slats 64 are connected and configured to pass sequentially beneath the spring heat treatment region as illustrated in FIG. 9(a) with the length, Lₛ, of each slat oriented parallel to the length of the spring heat treatment region and at least as great as the length Lhtr of the spring heat treatment region as in other examples of the invention. Continuous rotation of the spring batch (that is, one or more coil springs) loaded in the spring heat treatment region is accomplished by a friction force established between the springs seated on the upper surfaces 64a of slats 64 passing below the heat treatment region and the upper surfaces 64a of the individual slats as the slats move sequentially beneath the spring heat treatment region when the belt or chain is being continuously driven, for example, in the direction of the arrows shown in the figures. In this embodiment of the invention when the spring batch in the heat treatment region has been heated to a required temperature, drive tilt actuator 66 is configured to tilt the right end 62a of the belt or chain downwards to a spring release angle T° at which angle, the upper horizontal plane HP formed by the upper surfaces 64a of the rotating individual slats tilts downward as shown in FIG. 9(b) to provide an opening between the bottom of the spring heat treatment region (at horizontal plane HP) and upper surfaces 64a of the rotating slats so that the heated one or more coil springs 90 in the heat treatment region roll downwards and gravity free fall from the slats to the next heat treatment station, for example, quench tank 50. After delivery of the heated coil springs to quench tank 50, drive tilt actuator 66 returns the right end 62a of the belt or chain to horizontal as shown in FIG. 9(a) and a new spring batch is loaded to the spring heat treatment region to repeat the coil spring heat treatment and release process cycle in FIG. 9(a) and FIG. 9(b). In other embodiments of the invention, after the spring batch in the heat treatment region has been heated to a required temperature, the rotating belt or chain with attached slats remains in the position shown in FIG. 9(a) while the heat treatment station, including channel inductor 12 and associated coil guides 14a and 14b are sufficiently raised to allow escape of heated springs 90 from the heat treatment region and gravity free fall downwards in a waterfall-like manner into quenchant tank 50. The electric induction system 11 shown in FIG. 9(a) and FIG. 9(b) provides a heat treatment process where rotation speed of the batch springs can be independent from the required spring heat cycle time. In alternative embodiments of the invention after the spring batch in the heat treatment region has been heated to a required temperature, the mechanical (or otherwise) driven rotating belt or chain is stopped and a heated spring pusher apparatus pushes the heated one or more springs transversely out of the heat treatment region in the −Y direction so that the heated springs gravity free fall off a transverse edge of the slats to the next heat treatment station.

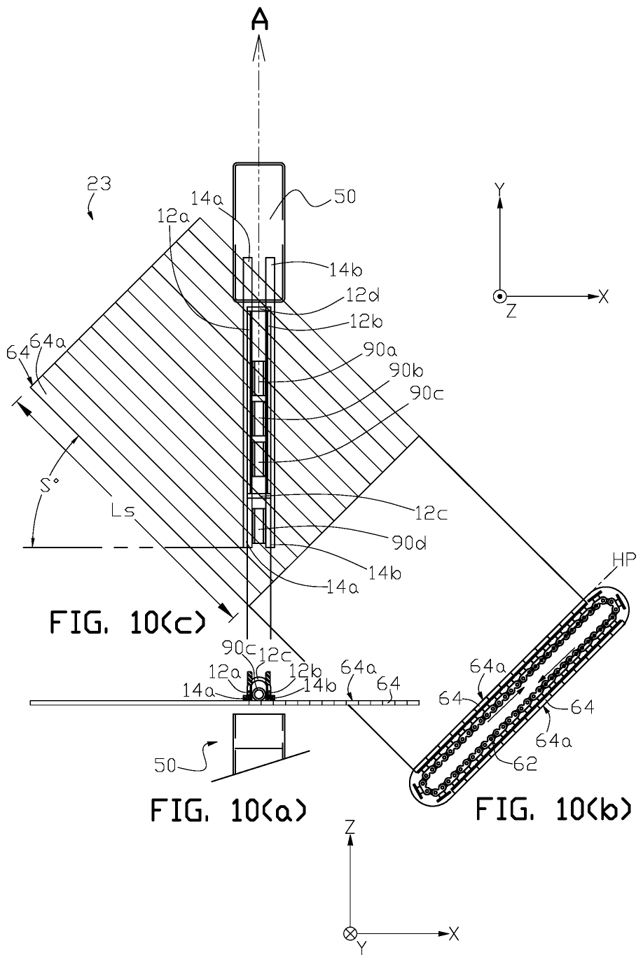

FIG. 10(a) through FIG. 10(c) illustrate an alternative embodiment of the present invention shown in FIG. 9(a) and FIG. 9(b) where the length, Lₛ, of slats 64 connected to mechanically (or otherwise) driven closed loop belt or chain 62 are disposed skewed to the length, Lhtr, of the spring heat treatment region as shown in FIG. 10(c), which is a top plan view illustrating the upper surfaces 64a of the top horizontal slats (shown as fourteen adjacent slats in FIG. 10(c)) disposed beneath channel inductor 12 with three springs 90a, 90b and 90c in the spring heat treatment region between inductor legs 12a and 12b and a fourth spring 90d ready for loading into the spring heat treatment region. The four springs are rotated and linearly advanced through the spring heat treatment region by friction contact with the upper surfaces 64a of rotating skewed slats 64 in the +Y direction as the mechanically (or otherwise) driven closed loop belt or chain 62 rotates. Therefore the axial (A axial direction) speed of the springs through the heat treatment region (from the entry end of the region at inductor crossover section 12c to the exit end of the region at inductor crossover section 12d) and the rate of heating of the springs are controlled in this embodiment of the invention by the rotational speed of the belt or chain and the skew angle S° of rotating skewed slats 64. In this example skew angle S° is measured relative to the perpendicular of the length of the heat treatment region; therefore an angle S of 90° represents no skew to the axial length of the heat treatment region. At the end of the spring heat treatment region each spring gravity free falls sequentially from the exit end of the region at inductor crossover section 12d to the next heat treatment station, for example, quench tank 50. FIG. 10(a) is a side elevation view of the entry end of the spring heat treatment station and region formed between the inductor legs 12a and 12b; the upper horizontal slats 64 disposed in the horizontal plane HP beneath channel inductor 12 and the quenchant tank 50 below the exit end of the spring heat treatment region, all of which are projected into the top plan view of FIG. 10(c). FIG. 10(b) is a side elevation view of the mechanically (or otherwise) driven continuous loop belt or chain 62 with the upper horizontal slats 64 projected into the top plan view of FIG. 10(c). In the embodiment of the invention shown in FIG. 10(c) springs can be continuously loaded linearly and sequentially onto spring guide rails 14a and 14b since springs continuously advance along the heat treatment region by continuous rotation of belt or chain 62 from entry into the heat treatment region to dropping down into quench tank 50 upon exit from the heat treatment region thanks to the skew angle rotation of slats 64 under the heat treatment region.

In all embodiments of the invention an optional feature is one or more flux concentrators positioned in one or more locations in, or adjacent to, the spring heat treatment region along the axial length of at least one of the channel inductor legs to influence the shape of the magnetic flux field established by AC current flow in the channel inductor, and therefore influence the inductively heated spring temperature distribution along the axial length of a spring being inductively heated within the channel inductor legs. One application of flux concentrators in the present invention is to provide a uniform heated spring temperature distribution along the entire axial length of a spring when the spring being heated is a complex shaped spring. A complex shaped spring in this optional embodiment of the invention includes coil springs having a variable coil axial length of constant cross sectional dimension.

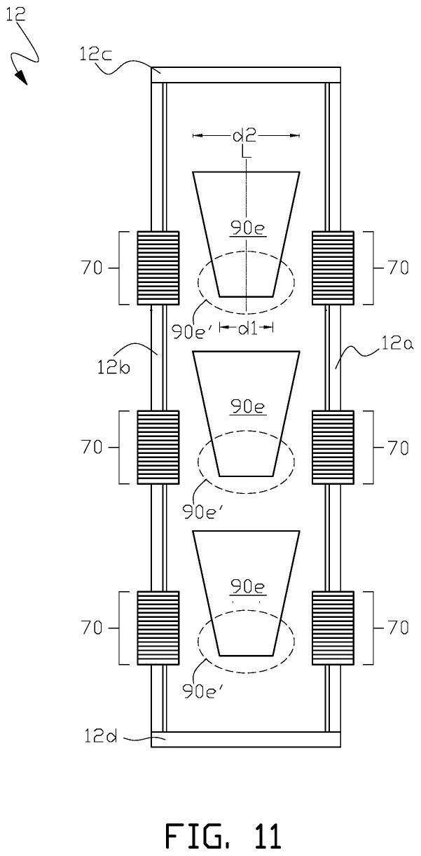

For the example in FIG. 11 where three identical complex conical springs 90e with the small diameter end having an outer diameter of dl and the large diameter end having an outer diameter of d2, are being heat treated between inductor legs 12a and 12b of channel inductor 12 in any of the embodiments of the present invention, one or more magnetic flux concentrators 70 are applied to the inductor leg regions that correspond to electromagnetically decoupled regions 90e′ of the conical springs that is commonly associated with a conical spring's smaller diameter regions. The flux concentrators intensify induction heating of the electromagnetically decoupled regions 90e′ to compensate for a deficit of heat intensity at the smaller diameter end of the spring and produce a more uniform axial (longitudinal) temperature distribution of the heated spring.

The present invention has been described in terms of preferred examples and embodiments. Equivalents, alternatives and modifications, aside from those expressly stated, are possible and within the scope of the invention. Those skilled in the art, having the benefit of the teachings of this specification, may make modifications thereto without departing from the scope of the invention.

1. A coil spring electric induction heat treatment system comprising:
a channel inductor comprising a pair of planarly spaced apart rectangularly shaped legs respectively comprising a first inductor leg and a second inductor leg;
a first interior spring side guide attached to a first leg side of the first inductor leg and a second interior spring side guide attached to a second leg side of the second inductor leg;
a spring heat treatment region formed between the first interior spring side guide and the second interior spring side guide; and
a coil spring support structure disposed at least below the spring heat treatment region.

2. A coil spring electric induction heat treatment system of claim 1 wherein the coil spring support structure comprises a planar surface having a planar surface length at least equal to a length of the spring heat treatment region.

3. A coil spring electric induction heat treatment system of claim 2 further comprising a spring friction roller actuator connected to the planar surface.

4. A coil spring electric induction heat treatment system of claim 2 further comprising a spring escapement opening in the planar surface.

5. A coil spring electric induction heat treatment system of claim 2 wherein the planar surface is contoured or articulated.

6. A coil spring electric induction heat treatment system of claim 1 wherein the spring support structure comprises a plurality of moveable slats connected to a rotatable loop drive.

7. A coil spring electric induction heat treatment system of claim 6 wherein the plurality of moveable slats are longitudinally oriented parallel to the length of the heat treatment region.

8. A coil spring electric induction heat treatment system of claim 7 further comprising a drive tilt actuator.

9. A coil spring electric induction heat treatment system of claim 6 wherein the plurality of moveable slats are oriented at a skew angle to the length of the heat treatment region.

10. A coil spring electric induction heat treatment system of claim 1 further comprising a spring loader system moveably disposed above the spring heat treatment region, the spring loader system comprising:
a vertically oriented moveable spring feed tube for loading one or more coil springs to the heat treatment region;
a moveable spring escapement element having an escapement channel for receiving the one or more coil springs from the vertically oriented moveable spring feed tube; and
a spring load element disposed below the moveable spring escapement element, the spring load element having a spring load channel opening into the spring heat treatment region when the escapement channel is aligned with the spring load channel, a top surface of the spring load element forming a closed bottom of the escapement channel.

11. A coil spring electric induction heat treatment system of claim 1 wherein the channel inductor further comprises a first inductor crossover section and a second inductor crossover section electrically connecting the first inductor leg and the second inductor leg together respectively at an opposing first ends and an opposing second ends of the first inductor leg and the second inductor leg, the first inductor crossover section or the second inductor crossover section further comprising a first alternating current power terminal and a second alternating current power terminal, the first and the second alternating power terminals electrically isolated from each other.

12. A coil spring electric induction heat treatment system of claim 1 further comprising at least one flux concentrator attached to the first or second interior side guide or the first or second legs.

13. A method of a metallurgical heat treatment of one or more coil springs in the coil spring electric induction heat treatment system of claim 4, the method comprising:
depositing the one or more coil springs on the planar surface in the spring heat treatment region; and
friction rolling the one or more coil springs on the planar surface in the spring heat treatment region by a relative movement of the spring heat treatment region over a width of the planar surface while supplying an alternating current to the channel inductor to metallurgically heat treat the one or more coil springs.

14. A method according to claim 13 further comprising releasing the one or more coil springs from the heat treatment region by a relative movement of the spring heat treatment region over the width of the planar surface to a spring release region over the spring escapement opening.

15. A method of a metallurgical heat treatment of one or more coil springs in the coil spring electric induction heat treatment system of claim 8, the method comprising:
depositing the one or more coil springs on the plurality of moveable slats within the spring heat treatment region; and
friction rolling the one or more coil springs on the plurality of moveable slats moving through the spring heat treatment region by rotating the rotatable loop drive while supplying an alternating current to the channel inductor to metallurgically heat treat the one or more coil springs.

16. A method according to claim 15 further comprising tilting the rotatable loop drive to a spring release angle with the drive tilt actuator while rotating the rotatable loop drive whereby the one or more coil springs are released from the spring heat treatment region.

17. A method according to claim 15 further comprising raising the first and second inductor legs and the first and second interior spring side guides above the one or more springs in the spring heat treatment region while rotating the rotatable loop drive whereby the one or more coil springs are released from the spring heat treatment region.

18. A method according to claim 15 further comprising pushing the one or more coil spring transversely out of the heat treatment region.

19. A method of a metallurgical heat treatment of one or more coil springs in the coil spring electric induction heat treatment system of claim 9, the method comprising:
depositing the one or more coil springs on the plurality of moveable slats at an entrance to the heat treatment region; and
friction rolling the one or more coil springs on the plurality of moveable slats and the one or more coil springs axially through the spring heat treatment region by rotating the loop drive at a heat treatment rotational speed while supplying an alternating current to the channel inductor to metallurgically heat treat the one or more coil springs.
